(19) United States
(12) Patent Application Publication
(10) Pub. No.: US 2012/0281244 A1
(43) Pub. Date: Nov. 8, 2012

(54) SCANNER APPARATUS, RELATED METHOD AND COMPUTER PROGRAM PRODUCT

(75) Inventors: Mirko GUARNERA, San Giovanni La Punta (IT); Alfio CASTORINA, Linera (CT) (IT); Giuseppe SPAMPINATO, Catania (IT); Osvaldo M. COLAVIN, San Diego, CA (US); John BLOOMFIELD, Lewisville, TX (US); Armand HEKIMIAN, Plano, TX (US); Beatrice Varlehon, Plano, TX (US)

(73) Assignees: STMicroelectronics INC, COPPELL, TX (US); STMicroelectronics S.r.l., Agrate Brianza (IT)

(21) Appl. No.: 13/430,661

(22) Filed: Mar. 26, 2012

(30) Foreign Application Priority Data
Mar. 25, 2011 (IT) TO2011A000261

(51) Int. Cl. H04N 1/04; H04N 1/32; G06K 15/02

(52) U.S. Cl. 358/1.13; 358/482; 358/468

(57) ABSTRACT

An embodiment of an integrated scanner apparatus, includes a support surface for objects to be scanned, a scanner unit to perform a scanning movement relative to the support surface to capture images of portions of objects to be scanned, and a printer unit carried by a carriage mobile with respect to said support surface, wherein said scanner unit is carried by said carriage carrying said printer unit to be imparted said scanning movement by said carriage.

### PRIORITY CLAIM

The instant application claims priority to Italian Patent Application No. TO2011A000261, filed Mar. 25, 2011, which application is incorporated herein by reference in its entirety.

### TECHNICAL FIELD

An embodiment of the disclosure relates to a scanner apparatus. Certain embodiments may relate to a scanner apparatus integrated with a printer.

### BACKGROUND

A key part of printers and other conventional image-sensor devices is the Contact Image Sensor (CIS) scan bar, which transforms an image on paper into an electronic image. A CIS scan bar may be widely used for facsimile (fax) machines, optical scanners, and portable applications e.g. portable scanners.

Over the years, the cost of CMOS imaging-sensor arrays has decreased, and their performance level increased: these sensors may thus be used in the place of conventional CIS scan bars, giving rise to cheaper solutions without any adverse impact on scanner size.

Different solutions have been proposed in order to use CMOS/CCD imaging-sensor arrays to scan a document.

For instance, DE-A-102006010776, which is incorporated by reference, discloses an arrangement including four fixed CCD-sensors, which are located under a glass for supporting the documents to be scanned and which operate on the basis of a pre-calibrated evaluation algorithm to form an entire image.

Various documents disclose different kinds of image-sensor carriages for mounting image reading means in combination with a drive unit (driving motor) to move the carriage.

For instance, GB-A-2336734, which is incorporated by reference, discloses an image sensor arranged parallel to the short sides of a rectangular lower frame to capture the image of a scanned object placed on a transparent plate mounted on a rectangular upper frame. A rod-like guiding member is provided orthogonal to the longitudinal holder to guide the movement of the image sensor.

In the solution disclosed in JP-A-2005331533, which is incorporated by reference, an image scanner is equipped with a carriage on which an image sensor is mounted. A driving motor moves the carriage in a sub-scanning direction via a toothed timing belt.

US-A-2006/098252, which is incorporated by reference, discloses a drive device for a scanner which includes an elongate guiding unit mounted in a base and disposed under an image sensor carriage. A roller unit is mounted on a bottom side of the image sensor carriage and a driving unit drives the image sensor carriage in a second direction with respect to the base.

Documents such as US-A-2008/174836 and JP-A-20060245172, which are incorporated by reference, disclose a scanner device adapted to scan an object and generate image data; the scanner device includes an image sensor and a movement unit which moves in a sub-scan direction a carriage carrying the image sensor.

EP-A-0 886 429, which is incorporated by reference, discloses an image input/output apparatus capable of printing and reading images and a cartridge carriage for reading an original with a simple control: the system uses a camera module which replaces the ink cartridge, sharing the same circuitry, which may turn out to be critical for maintaining the same speed for printing and as regards manual replacement of the cartridges.

Document CN-A-201286132, which is incorporated by reference, discloses a planar-image sensor, high-speed scanner with a reading function, and a copying machine containing an image part, at the bottom of a workbench, which includes n sets of image detection parts and a set of image reading parts; a light-source part above the image part; and a reflection part above the light-source part. A main drawback of this solution may lie in that too many cameras may be needed to cover the entire document area.

Document US-A-2009/0021798, which is incorporated by reference, discloses a scanner operating system with a single camera module. Such an arrangement is implemented in an “All-in-One” (AiO) product traded by Lexmark® under the commercial designation Genesis, which uses a single fisheye lens. A main drawback of this arrangement lies in the negative impact on system height.

In brief, the idea of using one or more sensors (fixed or in motion) to scan an image (or part of an image) has been largely adopted. If the image sensor is intended to be moved in operation, these arrangements almost inevitably involve the use of an additional carriage for the sensor.

### SUMMARY

An embodiment dispenses with the intrinsic drawbacks of the arrangements considered in the foregoing.

An embodiment is achieved by an apparatus, a corresponding method, and a computer program product, loadable in the memory of at least one computer and including software code portions capable of implementing the steps of the method when the product is run on at least one computer.

Certain embodiments may exploit the ink cartridge carriage of a printer of the “All in One” (AiO) type to move the scanner module, which may include a set of aligned cameras, without the need of another sensor carriage.

Certain embodiments make it possible to compose the final document by fusing (“stitching”) together various acquired portions of the document.

### BRIEF DESCRIPTION OF THE DRAWINGS

Various embodiments will now be described, by way of example only, with reference to the annexed figures, in which:

FIG. 1 is a schematic representation of an embodiment;

FIG. 2 is representative of image shots taken in certain embodiments;

FIG. 3 is representative of possible positions of sensors in an embodiment;

FIG. 4 schematically represents a live preview of images in an embodiment;

FIG. 5 is representative of an exemplary pattern for use in certain embodiments;

FIG. 6 is a block diagram of an architecture of an embodiment;

FIGS. 7 and 8 are diagrams representative of modes of operation of embodiments;

FIG. 9 is a diagram of an embodiment of a processing pipeline;

FIG. 10 schematically represents various types of geometric distortions;

FIG. 11 shows an example of overlapping images; and

FIG. 12 represents an exemplary blending function for use in certain embodiments.

### DETAILED DESCRIPTION

Illustrated in the following description are various specific details aimed at an in-depth understanding of the embodiments. The embodiments may be obtained without one or more specific details, or through other methods, components, materials etc. In other cases, known structures, materials or operations are not shown or described in detail to avoid obscuring the various aspects of the embodiments. Reference to “an embodiment” in this description indicates that a particular configuration, structure or characteristic described regarding the embodiment is included in at least one embodiment. Hence, expressions such as “in an embodiment”, possibly present in various parts of this description do not necessarily refer to the same embodiment. Furthermore, particular configurations, structures or characteristics may be combined in any suitable manner in one or more embodiments. References herein are used for facilitating the reader and thus they do not define the scope of protection or the range of the embodiments.

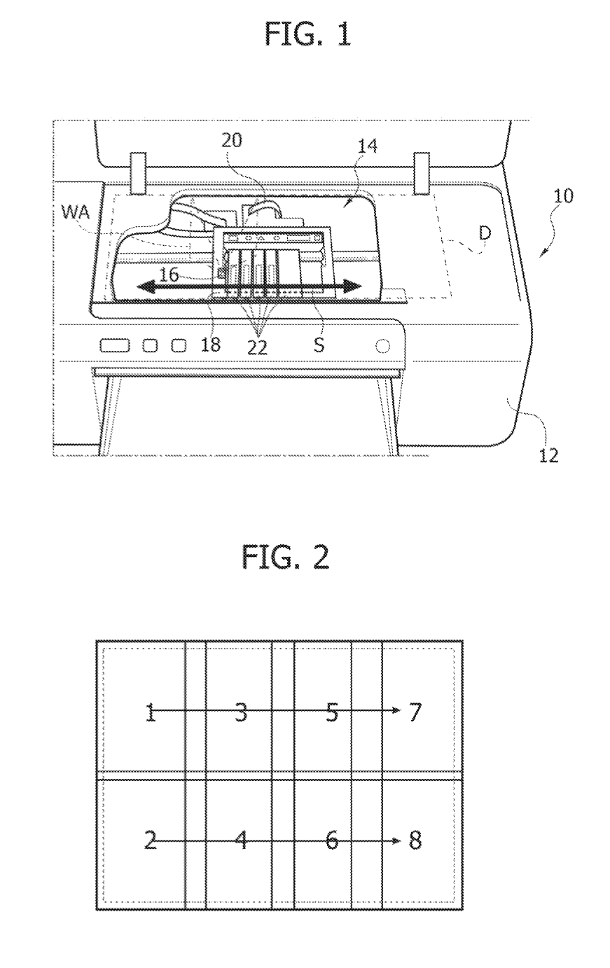

FIG. 1 is schematically representative of the general structure of an embodiment of a scanner apparatus 10.

As used herein, the designations “scanner apparatus” will apply to any type of apparatus adapted to provide a scanning function of, e.g., printed matter such as text and figures, possibly in conjunction with other functions such as, e.g., printing, copying, transmitting/receiving, or processing. Save for what is disclosed in detail in this disclosure, such scanning apparatus is conventional in the art, thus making it unnecessary to provide a more detailed description herein.

In the schematic representation of FIG. 1, the exemplary apparatus 10 includes a containment body or casing 12 having a transparent (e.g. glass) surface 14 or “platen” for lying thereon a document D to be scanned.

Scanning is performed by a sensor unit 16 (of any known type) to which is imparted a scanning movement (see the double arrow S in FIG. 1) by a motorized carriage 18.

Reference 20 denotes a flexible cable or “flex” which carries signals between the moving sensor/carriage unit 16 and the stationary portion of apparatus 10.

As already indicated, this general structure is conventional in the art, thus making it unnecessary to provide a more detailed description herein.

The scanning movement S enables the scanning window WA of the sensor 16 to subsequently cover (i.e. “frame”) various portions of the object D being scanned (see e.g. 1, 3; 5, 7 o 2, 4; 6, 8 in FIG. 2) and produce respective partial images of the object D.

In certain embodiments, the sensor unit 16, such as e.g. one or more VGA (Video Graphics Array) module or modules, may be mounted directly on the ink cartridge carriage as provided in apparatus 10 configured for acting also as a printer (e.g. in photocopiers, facsimile apparatus, and the like).

In certain embodiments, the carriage 18 carrying the sensor unit 16 is the same carriage carrying a printer unit (22) including one or more ink reservoirs.

In certain embodiments, the exemplary integrated scanner apparatus considered herein may thus include a support surface 14 for objects to be scanned (e.g. a document D) as well as a scanner unit 16 to perform a scanning movement S relative to the support surface 14 to capture images of portions of objects D to be scanned. A printer unit 22 is carried by a carriage 18 mobile with respect to the support surface 14; the scanner unit 16 is thus carried by the same carriage 18 carrying the printer unit 22 and is thus imparted the scanning movement S by the carriage 18.

In certain embodiments, the printer unit 22 carried by the carriage 18 includes at least one ink reservoir.

In certain embodiments, a number of “shots” (i.e., partial images) of the material being scanned, such as the document D, may be taken as this common carriage 18 is moved (see arrow S). These shots may then be fused or “stitched” together (for example, via software) to produce a final complete image CI. The resolution may be determined by the number of shots taken and the distance from the sensor unit 16 to the document D.

FIG. 2 is schematically representative of embodiments where the sensor unit 16 may be operated in such a way that plural (e.g. two) sets of different shots (namely 1, 3, 5, 7 and 2, 4, 6, 8, respectively) will be taken and fused (i.e. combined or “stitched”) to obtain a final image CI.

For instance, in certain embodiments, the sensor unit 16 may include two modules 16A, 16B, so that (two) sets of different shots (namely 1, 3, 5, 7 for the first module and 2, 4, 6, 8 for the second module) will be taken during a single stroke of the carriage 18 and fused (i.e. combined or “stitched”) to obtain a final image CI.

Certain embodiments may use a single module producing all of the partial images as follows: images 1,3,5,7 are captured while the carriage is moving in one direction, followed by a translation of the module in the orthogonal direction (which can be achieved purely by mechanical means), followed by a carriage movement in the opposite direction during which partial images 8,6,4,2 are captured, in that order. This approach trades cost (a single module) for time (partial images are captured serially instead of two at a time, roughly doubling the total capture time)

In certain embodiments, the exemplary integrated scanner apparatus considered herein may thus include at least one scanner module, each module having a capture window WA (FIG. 1) adapted to cover a portion of the objects D to be scanned; during the scanning movement S imparted by the carriage 18, each scanner module 16A, 16B produces a plurality of partial images (namely 1, 3, 5, 7 and 2, 4, 6, 8, respectively) of the objects D to be scanned. As better detailed in the following, a processing module 26 may be provided to fuse the plurality of partial images into a complete image (CI).

Similarly, in certain embodiments, the exemplary integrated scanner apparatus considered herein may include a plurality of scanner modules (e.g. two scanner modules 16A, 16B); during the scanning movement S imparted by the carriage 18, each sensor module 16A, 16B will produce a respective set of partial images (that is images 1, 3, 5, 7 for the module 16A and images 2, 4, 6, 8 for the module 16B) of the objects D being scanned. A processing module 26 may be provided to fuse the respective sets of partial images (1, 3, 5, 7 with 2, 4, 6, 8, respectively) into a complete image (CI).

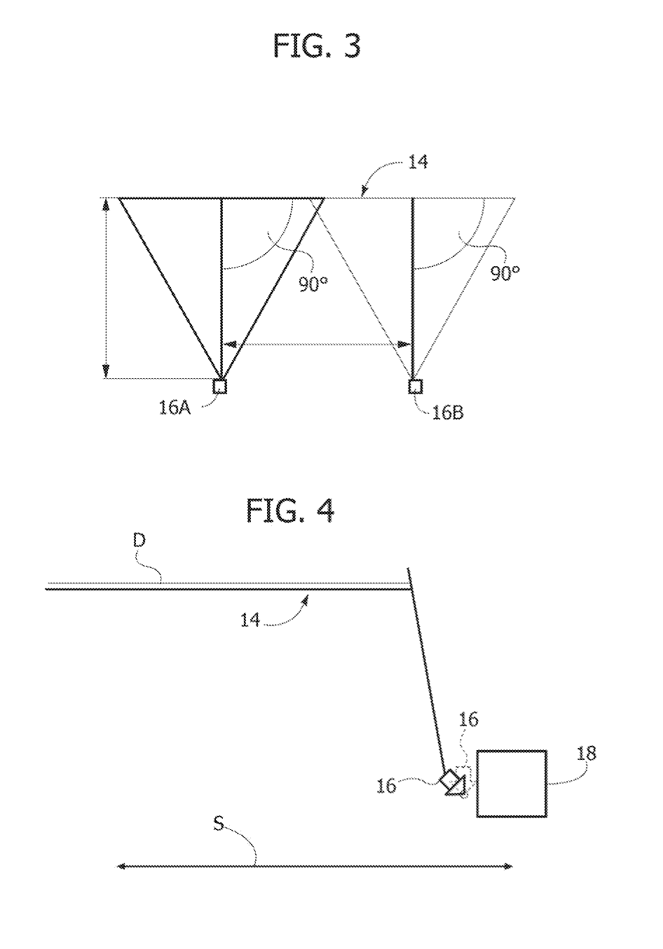

In certain embodiments, as schematically represented in FIG. 3, the modules or cameras 16A, 16B may be arranged orthogonal to the plane of the “platen” 14 (and thus of the document D laid thereon), which will remove any “keystone” effect, so that keystone correction will not be necessary.

In certain embodiments, absolute orientation and straightening may be applied, as better detailed in the following.

In certain embodiments, two modules or cameras 16A, 16B with a HFoV (Horizontal Field of View) of 60 degrees, located, e.g., 96 mm from the platen/document plane, may be able to capture a smallest dimension of an A4 or a US letter document (8.5×11 inches).

In certain embodiments, a quick live preview may be performed as schematically exemplified in FIG. 4.

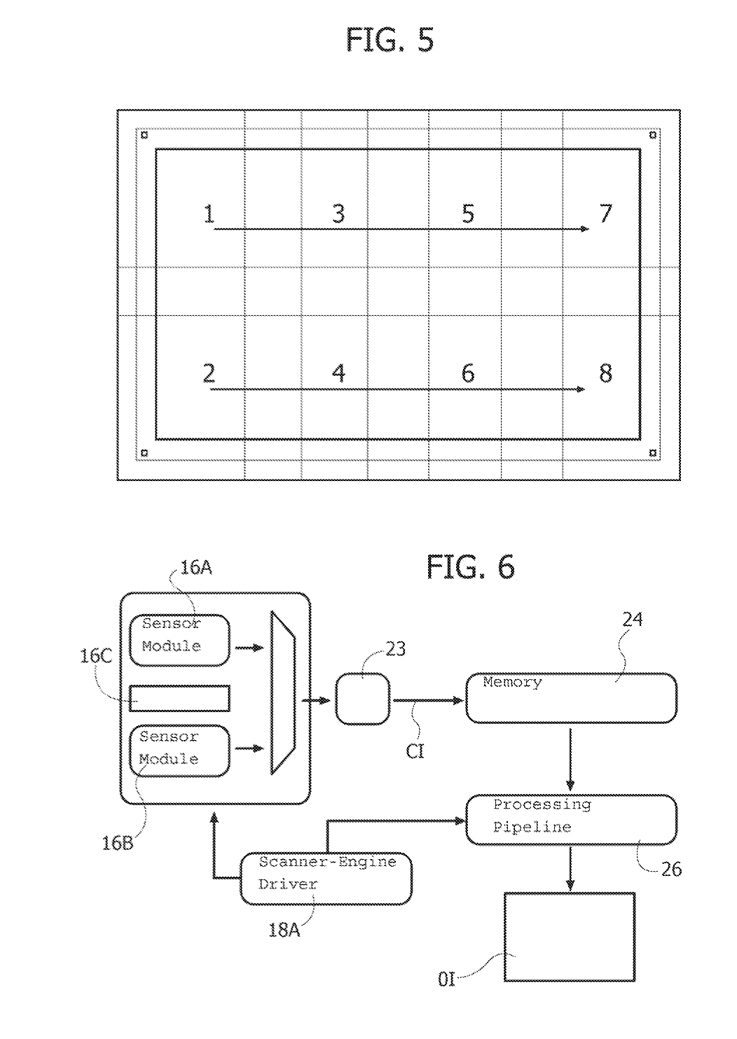

FIG. 4 assumes that the carriage 18 is in a “parked” mode. A sensor 16 may then be inclined (i.e. tilted) from the vertical position used during capture (in shadow lines in FIG. 4) to an oblique position (in full lines in FIG. 4) in order to capture in its field of view the entire document. The sensor 16 will capture the document D lying on the platen 14; the perspective generated by the inclination of the sensor can be corrected on the fly to restore the document: this is essentially a keystone effect, easy to be corrected with conventional correction techniques. Quality may be low but sufficient for preview. Behind (i.e. above) the platen 14, a test chart, arranged along the document sides, may be placed to be visible by the sensor(s) only. This may be used to help the system in case of black documents and to perform final geometric corrections, by exploiting the extraction of keypoints on the test chart. An exemplary test pattern is shown in FIG. 5, again by referring to two sets of partial images 1, 3, 5, 7 (sensor module 16A) and 2, 4, 6, 8 (sensor module 16B).

In certain embodiments, the exemplary integrated scanner apparatus considered herein may thus provide for the scanner unit 16 being selectively tiltable to a preview scanning position wherein the scanner unit 16 images a document to be scanned from a stationary position.

As regards signal generation/processing, certain embodiments may adopt the architecture exemplified in the block diagram of FIG. 6, including:
one or more, e.g. two, sensor modules 16A, 16B and an associated light source, e.g., flashlight, 16C carried by the carriage 18;
a processing device (e.g. a ISP) 23 to obtain image signals from the signals produces by the sensor modules 16A, 16B;
a memory 24 to store the images collected via the device 23;
a scanner-engine driver 18A to control the position/movement S of the carriage 18;
a processing (“fusing” or “stitching”) pipeline 26 to generate a final image OI, possibly in the preview mode considered in the foregoing.

Certain embodiments may admit at least two main operational modes, namely an open loop mode and a closed loop mode.

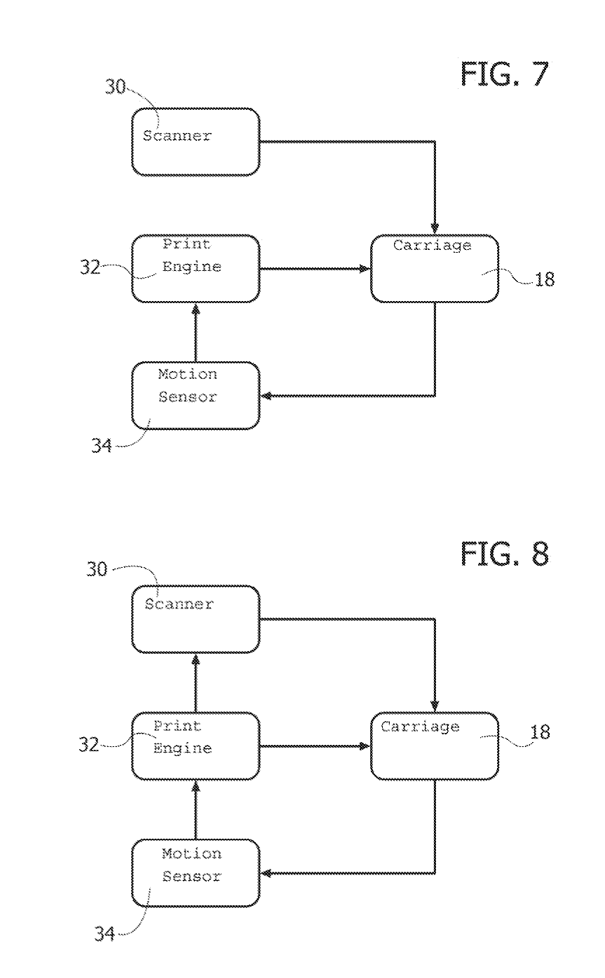

In certain embodiments, in the open loop mode, as schematically represented in FIG. 7, no interaction may be provided between the scanner module or modules 16A, 16B and the printing module carried by the carriage 18. That is, the scanner modules (which are represented in FIGS. 7 and 8 as a scanner “engine” 30) may not use the feedback on the real head position available (only) to the printing module (which is represented in FIGS. 7 and 8 as a print “engine” 32 such as a ASIC) as provided by a (e.g. linear) encoder 34. In this case, the processing pipeline 26 (FIG. 6) may contain a stitching phase where the sensor displacement parameters (i.e. the position at which a certain shot was taken) are calculated at run time.

In the open loop case, the scanner module 30 and the printing module 32 may be considered completely independent of each other, i.e. the scanner unit 16 will be operated independently of any feedback on the current position of the printing module 32 as provided by the motion sensor/encoder 34 associated with the carriage 18.

In certain embodiments, in the closed loop mode, as schematically represented in FIG. 8, the scanner module 30 may take into account the feedback on the current position of the printing module 32 as provided to the print engine 32 by the encoder 34 during the printing phase.

In certain embodiments, in the closed loop mode, the scanner module 30 may exploit the information provided by the encoder 34 through the printer ASIC 32. In this mode, the real position may be used by the stitching module in the processing pipeline (26 in FIG. 6) to obtain precise information of the acquisition position.

In certain embodiments, the carriage 18 may thus have associated therewith a motion sensor 34 providing a feedback signal representative of the position of the carriage 18; the scanner unit 16 is then operable as a function of the feedback signal.

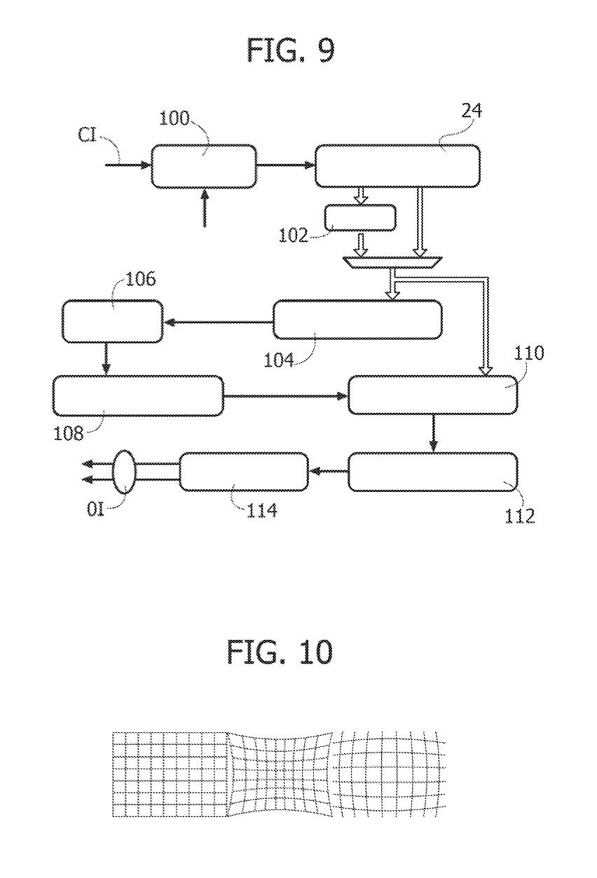

In certain embodiments, the processing pipeline 26 may have the structure represented in FIG. 9.

In FIG. 9, block 100 is representative of a first step in the exemplary pipeline considered, wherein geometric correction is performed to apply the estimated intrinsic sensor/system parameters (obtained with external tools) to correct geometric distortions in the images CI (as derived, e.g., from the ISP 23).

In certain embodiments as exemplified in FIG. 9, geometric correction may be performed “upstream” of the memory 24, that is before the images are stored in the memory 24. In certain embodiments, geometric corrections may be performed “downstream” of the memory 24.

In certain embodiments, the pipeline 26 may operate the first time with a re-sized version of the images produced in a sub-step 102 to obtain a preview, while the second time it works with the full resolution version of the images.

In certain embodiments, to these (partial) images the following blocks/processing steps may be applied:
104—keypoint detection and matching, to match feature points (calculated by conventional keypoint descriptor methodologies, such as SIFT/SURF);
106—outlier removal using, e.g., conventional techniques such as RANSAC (Random Sample Consensus) technique;
108—global registration, performed on correspondences while also estimating the registration parameters.

Stitching (i.e. fusing together) the images (as derived from the memory 24) is performed in a block/step 110 using the parameters estimated while also possibly applying seamless blending to avoid seams between images.

The complete image thus obtained may then be subjected to the following blocks/processing steps:
112—global straightening, which may be a final post-processing step (similar to keystone) to ensure image ‘squareness’;
114—post processing such as, e.g., a further-color-enhancements algorithm to be globally applied to the image, such as white-point detection and application, color contrast, etc., to finally produce as a result a final image (which may be represented also by a preview image captured as explained previously).

Those of skill in the art will otherwise appreciate that, while representative of the best mode, the embodiment of the pipeline depicted in FIG. 9 is exemplary in its nature.

In certain embodiments, the pipeline may be supplemented with further, additional steps. Also, in certain embodiments, one or more of the steps considered herein may be absent or performed differently: e.g., (by way of non-limiting example) the step 114 may be performed off-line whenever this appears preferable (errors in reconstruction).

As schematically represented in FIG. 10, geometric distortions may be of two kinds: barrel and pincushion distortions. Both types of distortions can be reduced by using proper off-line tools to estimate the intrinsic parameters to be applied to the images taken by the sensor.

In various embodiments, two kinds of tools may be used, namely multiplane-camera calibration and lens-distortion-model estimation, respectively.

In multiplane-camera calibration, all the intrinsic parameters (focal length, principal point, and distortion parameters) may be calculated using several images (usually 15-20), taken using a checkerboard, pasted on a rigid planar surface, in different positions. Intrinsic parameters may be estimated by using the Bouguet calibration Matlab toolbox (see http://www.vision.caltech.edu/bougueti/calib_doc/index.html) mainly based on the work Z. Zhang: “Flexible Camera Calibration by Viewing a Plane from Unknown Orientations,” Seventh International Conference on Computer Vision (ICCV), Volume 1, pp. 666-673, 1999, which is incorporated by reference. Other tools can be used in the same way, such as disclosed, e.g., in http://www.ics.forth.gr/˜xmpalt/research/camcalib_wiz/index.html and http://matt.loper.org/CamChecker/CamChecker_docs/html/index.html both based on the above mentioned work of Z. Zhang, and both incorporated by reference.

CAMCAL may be another tool (see http://people.scs.carleton.ca/˜c_shu/Research/Projects/CAMcal/, which is incorporated by reference and which uses a different approach as disclosed, e.g. in A. Brunton, et al.: “Automatic Grid Finding in Calibration Patterns Using Delaunay Triangulation”, Technical Report NRC-46497/ERB-1104, 2003, which is incorporated by reference, and an ad-hoc test pattern.

If the lens-distortion-model estimation is used, only distortion parameters may be calculated using a single pattern image, usually tracing lines on the pattern.

To estimate the parameters, standard methodologies can be exploited, such as the CMLA tool (see e.g. http://mw.cmla.ens-cachan.fr/megawave/demo/lens_distortion/, which is incorporated by reference). In certain embodiments, a checkerboard pattern may be used, taken exactly in front of the camera, without rotation to simplify the work of tracing horizontal and vertical lines. The captioned tool will know where these points are actually located (by deriving this information from the grid of the pattern image) and where these points should be (thanks to user manual lines specification), and simply solve a system to determine the distortion parameters.

In certain embodiments, a color-correction procedure may be optionally applied (possibly after the camera—i.e. sensor module—calibration) to correct shading discontinuities. In certain embodiments, a Linear Histogram Transform (LHT) may be adopted, forcing selected areas to have the same mean value and variance.

By way of example, the following equations may be used to gather statistics on a selected area:

$${E}_{c} = \frac{{\sum }_{i = 0}^{\# pixels} {pixel}_{ci}}{\# pixels} \\ {E}_{c}^{2} = \frac{{\sum }_{i = 0}^{\# pixels} \vert {pixel}_{ci} - {E}_{C} \vert}{\# pixels} \qquad ( 4 )$$

and correction may be performed as follows:

$$out = \frac{{preE}_{C}^{2}}{{currE}_{C}^{2}} \cdot ( {pixel}_{c} - {currE}_{C} ) + {prevE}_{C}$$

In certain embodiments, keystone correction may be another optional step, possibly applied after color correction.

In certain embodiments, before applying keystone correction, in an offline tuning phase, a rotation step may be performed to align the image on axis. To do this, the Hough transform may be applied on a chessboard-patch gradient image (as obtained, e.g., by a simple horizontal Sobel filtering).

As regards keypoint detection and matching (block 104 in FIG. 9), in certain embodiments the related procedure may include, in addition to feature extraction and matching properly, also an outlier removal step ((block 106 in FIG. 9).

In various embodiments, the first step/phase may extract the characteristic features for each image and match these features for each couple of images to obtain the correspondence points, while the second step may filter the obtained points to be in line with the chosen model (rigid, affine, homographic and so on).

As already indicated, in certain embodiments the features may be extracted using the SIFT or SURF transforms as disclosed, e.g., in D. Lowe: “Distinctive Image Features from Scale-Invariant Keypoints”, International Journal of Computer Vision 60 (2): 91-110, 2004 and H. Bay, et al.: “SURF: Speeded Up Robust Features”, Computer Vision and Image Understanding (CVIU), Vol. 110, No. 3, pp. 346-359, 2008), which are incorporated by reference, and the matches may be made accordingly.

In certain embodiments, a high number of outliers may be easily noticed in the case of final matches obtained via SIFT.

In certain embodiments, in order to remove outliers, the final matches obtained in the previous step may be filtered through RANSAC (Random Sample On Consensus Set).

In certain embodiments, this technique may involve the following steps:
select in a random fashion a minimal number of samples to estimate registration;
estimate registration;
discard samples which are not in agreement with estimated motion;
repeat the process until the probability of outliers falls under a threshold; and
use a maximum number of inliers to estimate final registration.

Certain embodiments may include global registration (block 108 of FIG. 9).

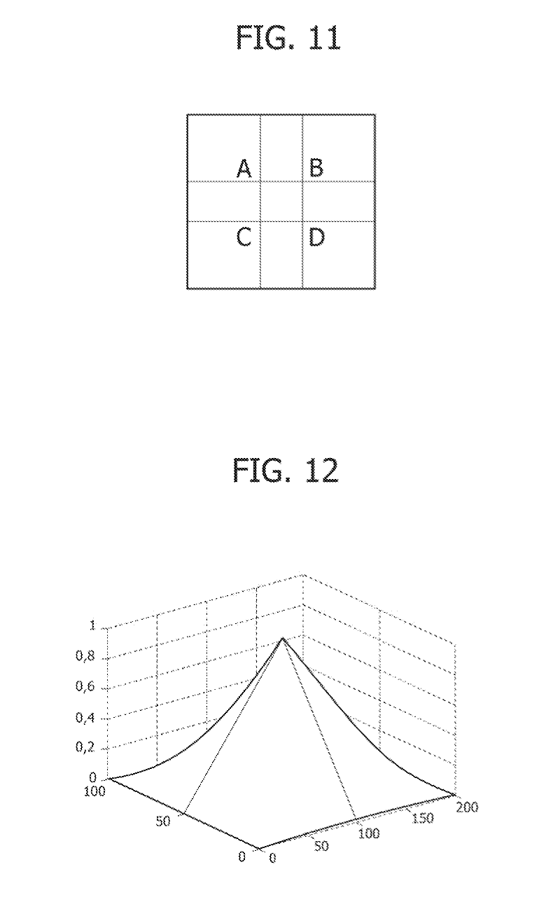

In certain embodiments, in global registration of a set of images, all overlapping pairs should be considered. In the example of FIG. 11, four images (A, B, C, D) may be considered, so all the possible pairs resulting from combinations are: (A,B), (A,C), (A,D), (B-C), (B-D), (C-D).

The registration may take into account simultaneous warping effects. One image, for example A, may be used as a “world” reference (i.e. all images may be registered with respect to A).

In an example, the system constraints will be:

H_{AA}=I

H_{AA}x₁=H_{AB}x₂

H_{AA}x₃=H_{AC}x₄

H_{AA}x₅=H_{AD}x₆

H_{AB}x₇=H_{AC}x₈

H_{AB}x₉=H_{AD}x₁₀

H_{AC}x₁₁=H_{AD}x₁₂ (5)

where Hᵢⱼ denotes the motion matrix to register image j on image i.

The corresponding motion models may be rigid (6), affine (7), and homographic (8), respectively:

$$\begin{matrix}{x}^{′} = ax + by + c \\ {y}^{′} = bx - ay + f & ( 6 ) \\ {x}^{′} = ax + by + c \\ {y}^{′} = dx + ey + f & ( 7 ) \\ {x}^{′} = \frac{ax + by + c}{dx + ey + 1} \\ {y}^{′} = \frac{fx + gy + h}{ix + ly + 1} & ( 8 )\end{matrix}$$

In case of rigid and affine motion, the constraints may lead to an over-determined system of linear equations of the kind Ax=B, which can be easily solved with least squares methods.

In certain embodiments, image stitching (step 110 of FIG. 9) may involve the use of seamless blending in order to avoid image discontinuities; output images may be blended using a proper weighting function, in which weights decrease from the image center towards the edges.

An example of this kind of function is shown in FIG. 12.

In certain embodiments, global straightening (block 112 of FIG. 9) may be included to ensure, via a step similar to keystone removal, image ‘squareness’.

In certain embodiments, in order to execute this step a pattern test image is used, which may be produced by composing blank documents and/or documents with points with lack of interest to be inserted under hidden parts of the system.

In certain embodiments, this may also help in the point matching step. In certain embodiments, by using on the borders ‘wordart like’ letters and numbers, the test pattern image thus created may contain black squares. These squares may be matched with known pattern using SAD (Sum of Absolute Difference) computation. Once the corners (at least four) are found, the correct rectangle can be estimated and the correction (using homographic model) performed. Homographic parameters may be estimated by means of linear system between matched and ideal corners.

In certain embodiments, both the input image and the test image may be subjected to sub-sampling (for example by two) in order to speed-up processing.

Certain embodiments may give rise to a low-cost scanning system using one or more sensors in movement to scan the image, without the need of another sensor carriage.

In certain embodiments a processing pipeline may be used which can be effectively implemented in software form.

Certain embodiments exhibit at least one of the following advantages:
fewer sensor modules/cameras (according to their Horizontal Field of View or HFoV) may be used to cover the horizontal dimension (in portrait mode) of the object being scanned;
the sensor modules/cameras may share a common carriage with the ink cartridge(s) and exploit the same head motor;
the head motor may be moved to fixed positions to capture portions of the document and the image portions thus captures may be fused (“stitched”) to create a final document;
the overall cost of the scanner unit may be reduced essentially to the cost of the sensor modules/cameras (plus associated elements, e.g., flashlight(s)), without any motor cost;
acquisition time may be reduced to a limited number of image shots;
system identification may be very simple: the sensor modules/cameras may be mounted on the ink-carriage and acquisition may be based on several shots (WA′, WA″, WA′″ ecc . . . ) at fixed positions.

Without prejudice to the underlying principles of the disclosure, the details and embodiments may vary, even significantly, with respect to what has been described herein by way of non-limiting example only, without departing from the scope of the disclosure.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1. An integrated scanner apparatus, including:
a support surface for objects to be scanned;
a scanner unit to perform a scanning movement relative to said support surface to capture images of portions of objects being scanned;
a printer unit carried by a carriage mobile with respect to said support surface,
wherein said scanner unit is carried by said carriage carrying said printer unit to be imparted said scanning movement by said carriage.

2. The apparatus of claim 1, wherein said printer unit carried by said carriage includes at least one ink reservoir.

3. The apparatus of claim 1, wherein said scanner unit is selectively tiltable to a preview scanning position wherein the scanner unit images a document to be scanned from a stationary position.

4. The apparatus of claim 1, wherein the scanner unit includes at least one scanner module having a capture window adapted to cover a portion of the objects to be scanned whereby during said scanning movement imparted by said carriage said at least one scanner module produces a plurality of partial images of the objects to be scanned, and wherein a processing module is provided to fuse said plurality of partial images into a complete image.

5. The apparatus of claim 1, wherein the scanner unit includes a plurality of scanner modules which, during said scanning movement imparted to said scanner unit by said carriage produces respective sets of partial images of the objects to be scanned, and wherein a processing module is provided to fuse said respective sets of partial images into a complete image.

6. The apparatus of claim 4, wherein:
said carriage has associated a motion sensor providing a feedback signal representative of the position of said carriage,
said scanner unit is operable independently of said feedback signal, and
said processing module is configured to calculate scanner unit displacement parameters for use in fusing said partial images.

7. The apparatus of claim 4, wherein:
said carriage has associated a motion sensor providing a feedback signal representative of the position of said carriage and of said scanner unit carried by said carriage;
said processing module is configured to receive said feedback signal and fuse said partial images as a function of said feedback signal.

8. An apparatus, comprising:
a carriage configured for motion; and
an image-capture unit coupled to the carriage and configured to capture images of respective portions of an object while the image-capture unit is in respective positions.

9. The apparatus of claim 8 wherein the carriage is configured for coupling to a member along which the carriage is configured to move.

10. The apparatus of claim 8 wherein the image-capture unit includes a CMOS pixel array.

11. The apparatus of claim 8 wherein the image-capture unit is configured to tilt relative to the carriage.

12. The apparatus of claim 8 wherein the image-capture unit is configured:
to tilt relative to the carriage; and
to capture an image of the entire object while tilted.

13. The apparatus of claim 8, further comprising a printer unit coupled to the carriage.

14. The apparatus of claim 8 wherein the object includes a document.

15. A system, comprising:
a transparent member configured to hold an object;
a carriage transporter disposed adjacent to the member;
a carriage coupled to the carriage transporter; and
an image-capture unit coupled to the carriage and configured to capture images of respective portions of the object while the carriage is in respective positions.

16. The system of claim 15 wherein the transparent member includes a plate of glass.

17. The system of claim 15 wherein the carriage transporter includes:
a travel member;
a carriage support coupled to the travel member and to which the carriage is coupled; and
a driver configured to move the carriage support along the travel member.

18. The system of claim 15 wherein the carriage transporter includes:
a travel member;
a carriage support coupled to the travel member and to which the carriage is coupled; and
a driver configured to step the carriage support along the travel member.

19. The system of claim 15, further comprising a carriage-position sensor.

20. The system of claim 15, further comprising:
a carriage-position sensor; and
wherein the image-capture unit is configured to capture at least one of the respective images in response to the carriage-position sensor.

21. The system of claim 15 wherein
the carriage transporter is configured to move the carriage in a direction during a period and in another direction during another period; and
the image-capture unit is configured to capture a subset of the respective images during the period and to capture another subset of the respective images during the other period.

22. The system of claim 15, further comprising a processor configured to generate from the respective images an image of the entire object.

23. The system of claim 15, further comprising a print unit coupled to the carriage and configured to impart a print material onto a print medium.

24. The system of claim 23 wherein:
the print material includes ink; and
the print medium includes paper.

25. The system of claim 15 wherein the image-capture unit is configured to capture a preview image of the entire object while the carriage transporter maintains the carriage in a stationary preview position.

26. A method, comprising:
moving an image-capture unit;
capturing images of respective parts of an object with the image-capture unit; and
generating an image of the object from the images of the parts of the object.

27. The method of claim 26 wherein capturing the images includes capturing the images while the image-capture unit is moving.

28. The method of claim 26 wherein:
moving the image-capture unit includes stepping the image-capture unit from location to location; and
capturing the images includes capturing each of the images while the image-capture unit is at a respective location.

29. The method of claim 26, further comprising moving a print unit while moving the image-capture unit.

30. The method of claim 26, further comprising:
maintaining the image-capture unit stationary; and
capturing an image of the whole object while the image-capture unit is stationary.

31. The method of claim 24 wherein:
moving the image-capture unit includes moving the image-capture unit in a direction during a period and in another direction during another period;
capturing images of the respective parts of the object includes
capturing a group of the images during the period and
capturing another group of the images during the other period; and
generating the image of the object includes generating the image from the groups of the images of the respective parts of the object.

32. A computer-readable medium storing instructions that, when executed by a processor, cause the processor:
to cause the moving of an image-capture unit;
to cause the image-capture unit to capture images of respective parts of an object; and
to generate an image of the object from the images of the respective parts of the object.
